(19) United States
(12) Patent Application Publication
(10) Pub. No.: US 2014/0370467 A1
(43) Pub. Date: Dec. 18, 2014

(54) ARTIFICIAL FLORAL ARRANGEMENT AND METHOD FOR THERAPY

(71) Applicant: Phyllis STEVENSON, Florence, AL (US)

(72) Inventor: Phyllis STEVENSON, Florence, AL (US)

(21) Appl. No.: 13/916,572

(22) Filed: Jun. 12, 2013

(51) Int. Cl. A41G 1/00; A01G 5/04

(52) U.S. Cl. CPC A41G 1/001; A01G 5/04
USPC 434/81

(57) ABSTRACT

An artificial floral arrangement and method for providing therapy to a person suffering from a cognitive disorder, and in particular, Alzheimer's disease includes an elongate base having a top surface and opposite ends. At least pair of posts is secured to and extend upwardly from the top surface of the base. A corresponding pair of cleats are secured to the top surface of the base and positioned laterally outward of the posts at the opposite ends of the base. A carrier is attached to the cleats and routed between the corresponding pair of posts. A plurality of decorative components are supported by and suspended from the carrier between the posts. Each of the decorative components may be a relatively short length of a ribbon that is tied about the carrier to create the illusion of a floral arrangement. The artificial floral arrangement and method provides a simple yet meaningful, failure-free, repetitive therapeutic activity that allows an Alzheimer's patient to manipulate materials in a structured, safe and supervised environment.

### FIELD OF THE INVENTION

The present invention relates generally to decorative items, and further, to a method for providing therapy to persons suffering from a cognitive disorder. More particularly, the invention is an artificial floral arrangement and associated method for providing therapy to Alzheimer's patients.

### BACKGROUND OF THE INVENTION AND RELATED ART

Cognitive disorders are a category of metal health conditions that limit or reduce learning, memory, perception and problem solving abilities. Common cognitive disorders include amnesia, dementia, and delirium. The most common form of dementia is known as Alzheimer's disease. Alzheimer's disease is degenerative and there is no known cure at this time. Accordingly, Alzheimer's patients rely exclusively on their caregivers for assistance in performing routine daily functions. In addition to giving assistance for daily activities, many caregivers provide therapy to Alzheimer's patients in the belief that therapy will improve the quality of life of the patient.

A number of different therapies for persons suffering from cognitive disorders, such as Alzheimer's disease have been proposed. Many health care professional agree that music therapy is beneficial to Alzheimer's patients. Listening to familiar music is calming, however, involving the patient in singing or playing a musical game has proven even more beneficial. According to the Fisher Center For Alzheimer's Research Foundation, structured, individualized activities that involve and interest a person with Alzheimer's may reduce some of the more disturbing behavioral symptoms of the disease, such as agitation, anger, frustration, depression and violent outbursts. The Fisher Center suggests that if possible therapeutic activities should focus on the person's previous interests and/or abilities, cue both the person's old and recent memories, and take advantage of the person's remaining skills while minimizing the impact of skills that have been compromised.

Beneficial therapies for Alzheimer's patients include activities that bolster a person's sense of self and draw upon their skills, habits and memories. Any former hobby or interest of the patient is a candidate for therapy, including crafts. Activities that are repeated on a regular schedule help establish routine and increase feelings of stability. Therapeutic gardening is known to be beneficial to Alzheimer's patients, but requires access to a suitable and favorable outdoor environment. Games, housework and accomplishing routine personal tasks are likewise believed to be therapeutic. Regardless, most caregivers agree that therapy for Alzheimer's patients should create simple yet meaningful, failure-free, repetitive activities that allow the person to manipulate materials in a safe and supervised environment.

Accordingly, there exists a need for an improved method for providing therapy to a person suffering from a cognitive condition. More specifically, there exists a need for a therapeutic activity and an associated method for providing therapy to Alzheimer's patients. Particularly, there exists a specific need for an article of manufacture that can be made by a person afflicted with Alzheimer's disease and an associated method for providing therapy to the Alzheimer's patient.

### SUMMARY OF THE INVENTION

The present invention is an artificial floral arrangement including an elongate base having opposite ends, at least a pair posts secured to and extending upwardly from the base adjacent the opposite ends of the base, and a corresponding pair of cleats secured to the base laterally outward of the posts at the opposite ends of the base. A carrier is attached to each of the cleats and routed between the corresponding posts. A plurality of decorative components are supported by and suspended from the carrier. In a preferred embodiment, each of the decorative components is a relatively short length of a ribbon that is tied about the carrier in the form of a bow to create the illusion of a floral arrangement. In another preferred embodiment, the carrier includes a carrier element that is a formable yet relatively inelastic length of cable, rope, string or wire having sufficient strength for supporting the plurality of decorative components.

A method according to the invention includes the step of providing an elongate base having opposite ends, at least a pair of posts secured to and extending upwardly from the base adjacent the opposite ends of the base, and a corresponding pair of cleats secured to the base laterally outward of the posts at the opposite ends of the base. The method includes the further steps of attaching a carrier to the pair of cleats and routing the carrier between the posts. The method includes the further step of disposing a plurality of decorative components from the carrier between the posts such that the decorative components are supported by and suspended from the carrier. In a preferred embodiment, each of the decorative components is a relatively short length of a ribbon that is tied about the carrier in the form of a bow to create the illusion of a floral arrangement. In another preferred embodiment, one or more of the aforementioned steps is accomplished by an Alzheimer's patient as a means for providing a relatively simple, repetitive, yet meaningful, task for enriching the life of an Alzheimer's patient.

Other aspects, objects, features and advantages of the present invention will be made apparent or will be readily understood and appreciated by those skilled in the related art as the invention is described in greater detail hereinafter and is shown in the accompanying drawing figures. It is envisioned that all such aspects, objects, features and advantages of the invention as shown and described herein will be within the intended broad scope of the appended claims. The above and other aspects, objects, features and advantages may be accomplished by any of the exemplary embodiments of the invention described herein and illustrated in the accompanying drawings. However, it should be appreciated that the drawing figures are for illustrative purposes only, and that many modifications, changes, revisions and substitutions may be made to the exemplary embodiments illustrated herein without departing from the broadest reasonable interpretation of the appended claims.

### BRIEF DESCRIPTION OF THE DRAWINGS

The aforementioned objects, features and attendant advantages of the present invention will be more fully understood and appreciated when considered in conjunction with the accompanying drawings, in which like reference characters designate the same or similar parts throughout the several views.

FIG. 1 is a top perspective view of a base for a decorative item, namely an artificial floral arrangement, according to an exemplary embodiment of the invention.

FIG. 2 is a detail perspective view of an end of the base of FIG. 1 showing a carrier attached at the end of the base.

FIG. 3 is a top perspective view of the base of FIG. 1 showing the carrier attached at the opposite ends of the base.

FIG. 4 is a side elevation view of the base and the carrier of FIG. 3.

FIG. 5 is a detail perspective view of the one end of the base and carrier of FIG. 3 showing typical decorative components disposed on the carrier.

FIG. 6 is a top perspective view of the base and the carrier of FIG. 3 showing a plurality of the decorative components medially disposed on the carrier between the opposite ends of the base.

FIG. 7 is a side elevation view of the base, carrier and plurality of decorative components of FIG. 6.

### DETAILED DESCRIPTION OF THE EXEMPLARY EMBODIMENTS

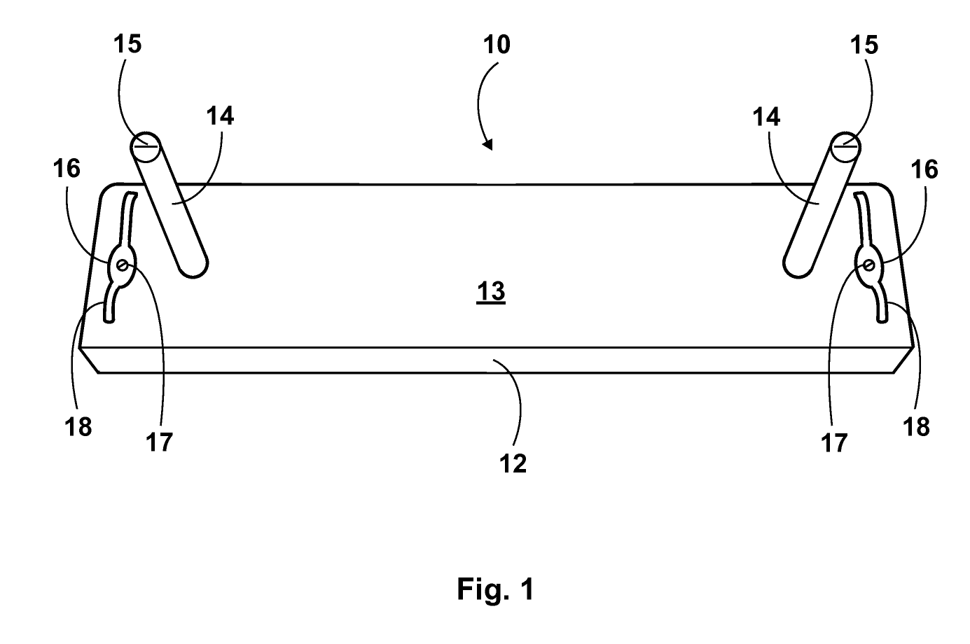

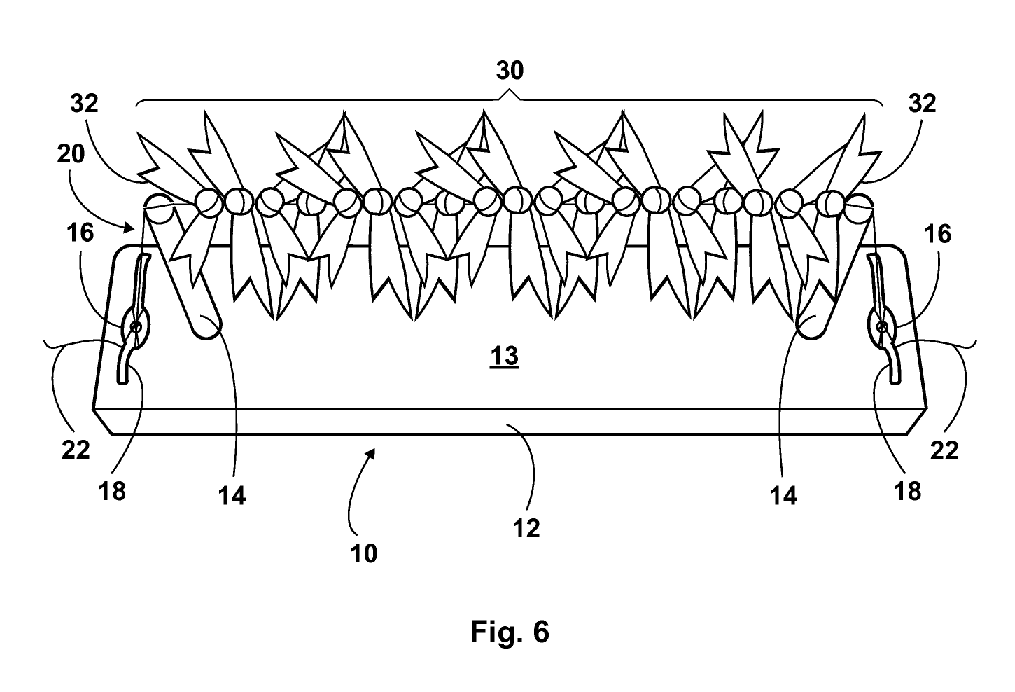

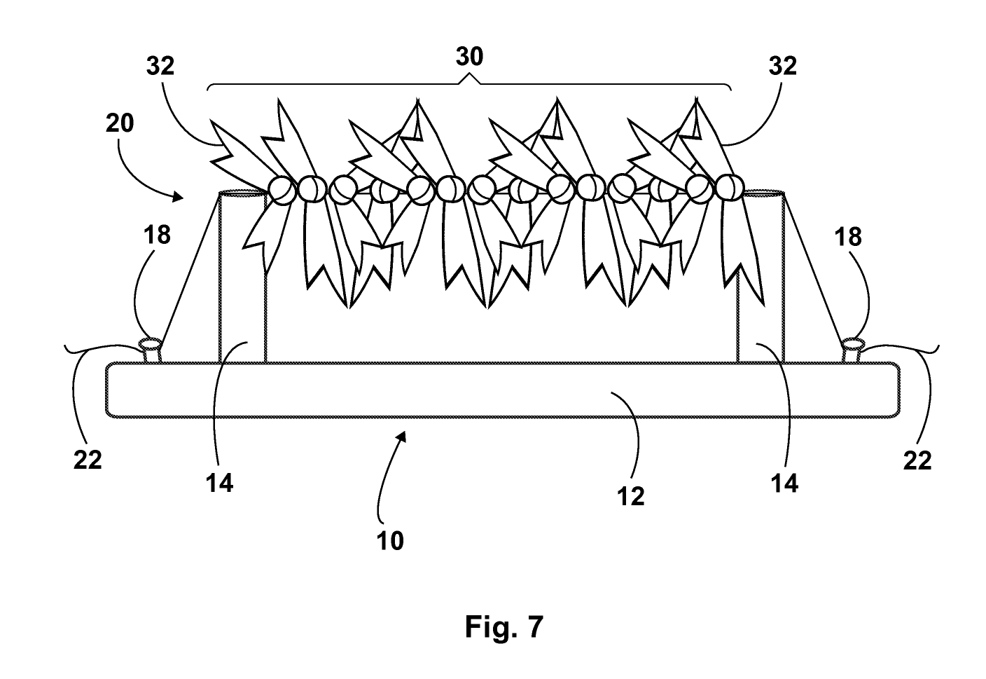

FIG. 1 shows a base of a decorative item, namely an artificial floral arrangement, according to an exemplary embodiment of the invention. The artificial floral arrangement, indicated generally by reference character 10 and shown in FIG. 6 and FIG. 7, may be made by an Alzheimer's patient according to an exemplary embodiment of a method for providing therapy. More specifically, in the exemplary embodiments of the invention shown and described herein, the artificial floral arrangement 10 is a decorative craft item configured to be made by an Alzheimer's patient that provides a simple yet meaningful, failure-free, repetitive therapeutic activity that allows the person to manipulate materials in a structured, safe and supervised environment.

As shown in FIG. 1, the artificial floral arrangement 10 comprises an elongate base 12. Base 12 is relatively thin and relatively narrow, and has a length that is significantly longer than its thickness and its width. Base 12 may be made of any suitable material, but in preferred embodiments base 12 is made of wood, plastic or composite material. An example of a suitable material and construction of base 12 is a length of a conventional wooden “2×4” board having dimensions of about 1% inches in height, about 3% inches in width and about 18-24 inches in length. However, the material, shape and dimensions of the base 12 are not essential to the concept of the invention. It is only necessary that the base 12 provides a stable platform for the remainder of the artificial floral arrangement 10, as will be described hereafter.

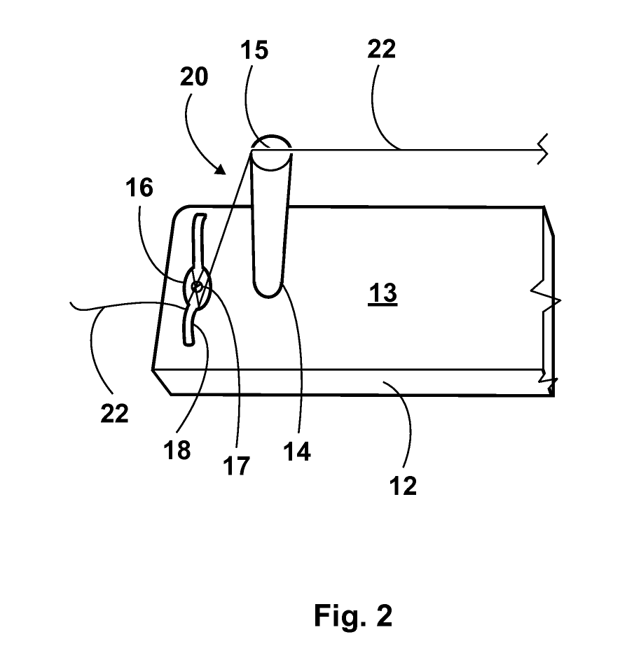

The artificial floral arrangement 10 further comprises at least a pair of supports, posts or the like 14 depending from the base 12. More particularly, and as illustrated in the exemplary embodiments shown herein, posts 14 extend upwardly from a top surface 13 of the base 12. If desired, a top surface of each post 12 may be formed with an optional indentation, cutout, groove, slot or the like 15 for a purpose to be described with reference to FIG. 2. The artificial floral arrangement 10 further comprises a pair of anchors, cleats or the like 16 secured to the top surface 13 of the base 12 at its opposed ends. Each cleat 16 is secured to the top surface 13 of the base 12 in a suitable manner, for example by an adhesive, or as shown herein, by a conventional fastener 17. Each cleat 16 is further configured with suitable means for retaining a carrier 20 thereon in a manner to be described with reference to FIG. 2. As shown in FIG. 1, each cleat 16 has at least one retaining arm 18 operable for retaining a portion of the carrier 20 thereon.

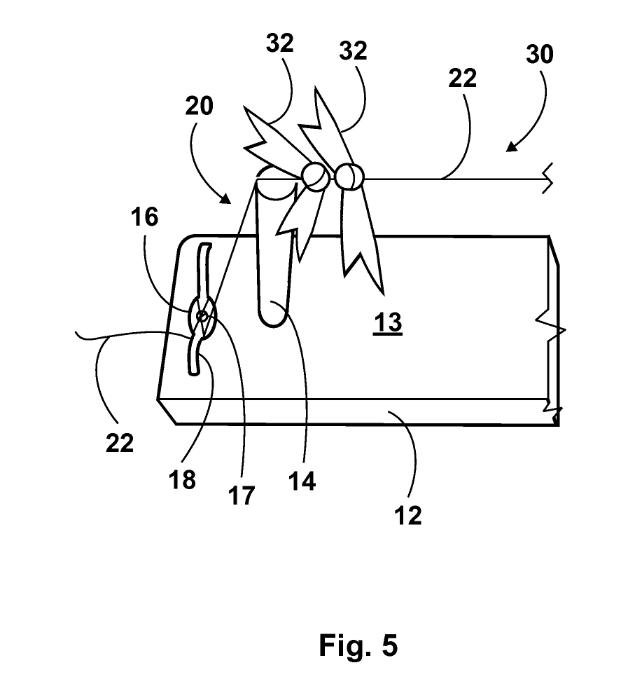

FIG. 2 is a detail perspective view of one end of the base 12 of the artificial floral arrangement 10 of FIG. 1 showing the carrier 20 attached thereto. The carrier 20 comprises a carrier element 22 consisting of an elongate length of a cable, rope, string, wire or the like having sufficient strength for supporting a plurality of decorative components 30 thereon in a manner to be described hereinafter with reference to FIG. 5. A first free end 24 of the carrier element 22 is attached to the cleat 16 provided at one end of the base 12 of the artificial floral arrangement 10. By way of example and as shown herein, first free end 24 is wound or wrapped around the retaining arm(s) 18 of the cleat 16 sufficiently to prevent the carrier element 22 from working loose from the cleat. For at least this reason, carrier element 22 is preferably made of an easily formable (e.g. bendable, twistable, etc.) relatively small diameter string or wire. Carrier element 22 may be somewhat elastic (i.e. stretchable), but preferably, is relatively inelastic so as to be able to support the weight of the plurality of decorative components 30. Regardless, the carrier 20 is routed in an upward direction at a slight acute angle from vertical to the top surface of the post 14 disposed at the one end of the base 12 of the artificial floral arrangement 10. If provided, the carrier 20 is disposed within the slot 15 formed in the top surface of the post 14 to partially secure the carrier element 22 on the post and to align the carrier element with the post at the opposite end of the base 12.

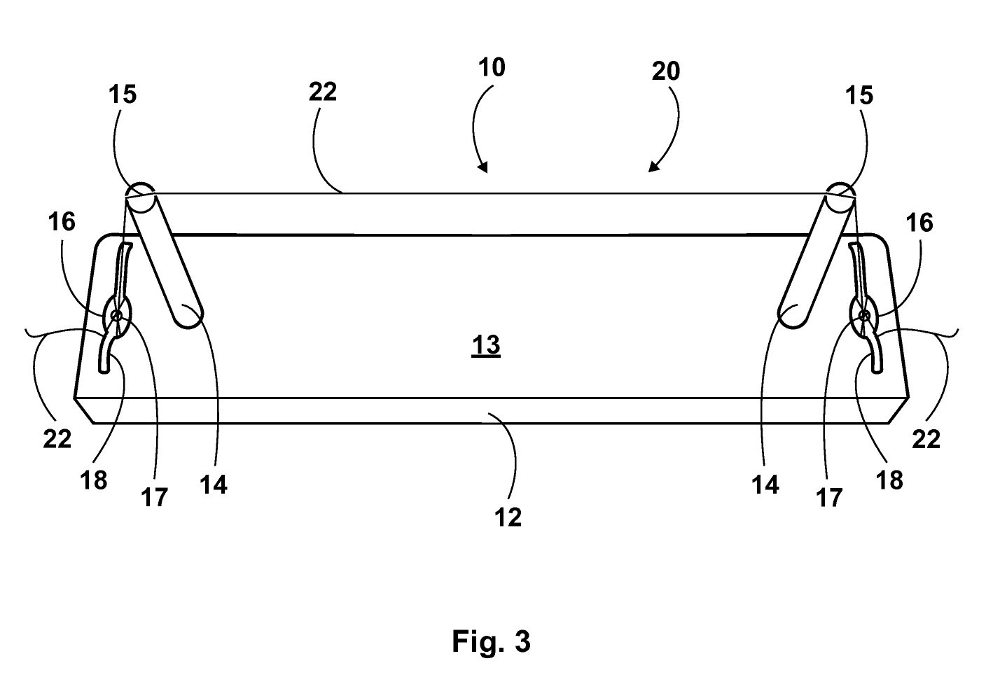

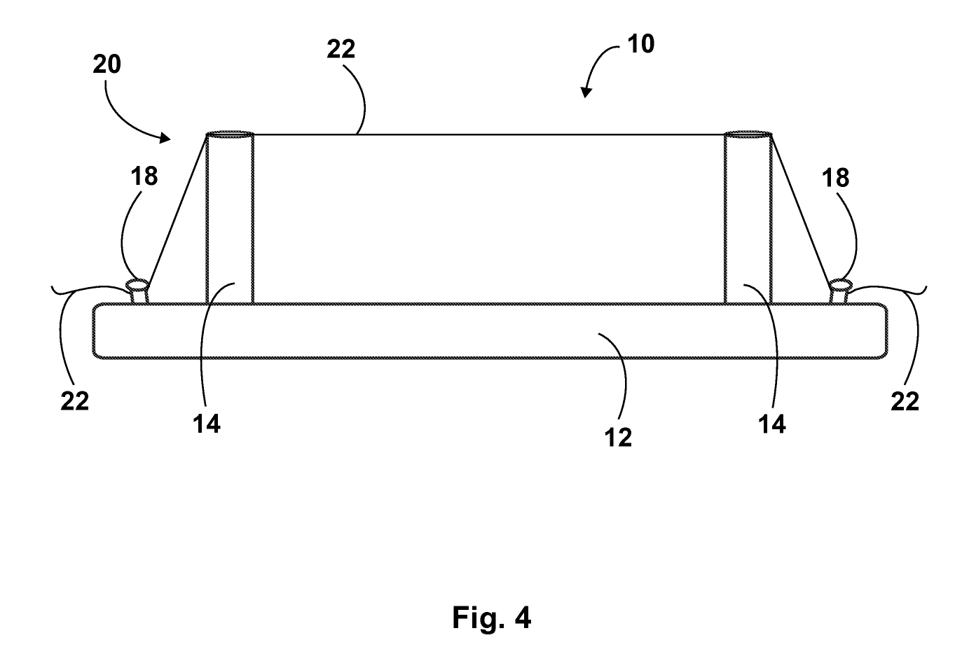

FIG. 3 is a perspective view of the base 12 and the carrier 20 of the artificial floral arrangement 10 showing the carrier element 22 attached at both of the opposite ends of the base. More particularly, the opposite first free end 24 and second free end 26 of the carrier element 22 are each attached to the cleat 16 disposed on the respective end of the base in a suitable manner. As previously described, the first free end 24 of the carrier element 22 may be wound or wrapped around the retaining arm(s) 18 of the cleat 16 at the one end of the base 12. The carrier element 22 may then be routed up to the post 14 at the one end of the base 12 and then along the length of the base to another post 14 disposed at the opposite end of the base. If desired, one or more other posts 14 may be disposed medially between the opposite ends of the base in a lengthwise direction to provide additional support for the carrier element 22 and the plurality of decorative components 30 supported on the carrier 20. Regardless, the second free end 26 of the carrier element 22 may then be routed from the other post 14 in a downward direction at a slight acute angle from vertical to the cleat 16 disposed at opposite end of the base 12 and attached thereto. In a preferred embodiment, the carrier element 22 is sufficiently taut between the posts 14 disposed at the opposite ends of the base 12 and is strong and inelastic enough to support the decorative components 30 thereon in a desired manner. FIG. 4 is a side elevation view of the base 12 and the carrier 20 of the artificial floral arrangement 10 in a fully assembled configuration.

FIG. 5 is a detail perspective view of one end of the base 12 and carrier 20 showing typical decorative components 30 disposed on the carrier element 22. For purposes of illustration only, each of the decorative components 30 is depicted herein as a relatively short length of ribbon 32 that is configured, for example tied, into the form of a bow onto the carrier element 22 of the carrier 20 at a medial location between the posts 14 at the opposite ends of the base 12 of the artificial floral arrangement 10. As will be readily understood and appreciated, a plurality of different colored ribbons 32 closely spaced along the length of the carrier element 22 between the posts 14 will create the illusion of a floral arrangement. FIG. 6 is a top perspective view of the base 12 and the carrier 20 showing a plurality of the decorative components 30 medially disposed on the carrier between the opposite ends of the base. FIG. 7 is a side elevation view of the base 12, carrier 20 and decorative components 30 of the artificial floral arrangement 10.

FIG. 6 and FIG. 7 illustrate a finished artificial floral arrangement 10 that is constructed in accordance with an exemplary embodiment of the invention. It should be noted that the decorative components 30 are shown and described herein as being made of an inorganic material. However, the decorative components 30 may alternatively be made of an organic material, and in a particularly advantageous example, made of organic flower or plant material. As will be readily understood and appreciated by those skilled in the art, the materials and the construction of the artificial floral arrangement 10 are relatively simple. Construction of the artificial floral arrangement 10 utilizes repetitive tasks and in many instances draws upon the past abilities, hobbies and/or crafts interests of the patient. As a result, creating an artificial floral arrangement 10 according to the invention provides a meaningful therapeutic activity for an Alzheimer's patient that is not excessively difficult and does not require special skills that could produce confusion, anxiety and frustration for the Alzheimer's patient or their caregivers.

A method 40 for providing therapy to a person suffering from a cognitive disorder, and in particular, Alzheimer's disease, includes the steps necessary for assembling the artificial floral arrangement 10. In an exemplary embodiment according to the invention, the method 40 comprises the step of providing a base 12, at least a pair of posts 14 and a corresponding pair of cleats 16. A further step of the method 40 comprises securing each of the posts 14 on a top surface 13 of the base 12 adjacent an opposite end of the base such that the posts extend upwardly from the top surface of the base. A further step of the method 40 comprises securing each of the cleats 16 on the top surface 13 of the base 12 laterally outside the corresponding post positioned at the opposite ends of the base. A further step of the method 40 comprises attaching a first free end 24 of a carrier 20 consisting of an elongate carrier element 22, for example a string or wire, to a first cleat 16 at a first opposite end of the base 12. The method 40 comprises the further step of routing the carrier element 22 from the first cleat 16 to a first post 14 adjacent the first opposite end of the base 12, from the first post to a second post 14 adjacent the second opposite end of the base, and from the second post to a second cleat 16 at the second opposite end of the base. The method 40 comprises the further step of attaching a second free end 26 of the carrier 20 to the second cleat 16 at the second opposite end of the base 12 with the carrier element 22 relatively taut between the first and second posts 14.

The method 40 comprises the further step of disposing a plurality of decorative components 30 on the carrier element 22 between the first and second posts 14 such that the decorative components are supported by and suspended from the carrier 20. The method 40 comprises the further step of closely spacing the decorative components 30 along the length of the carrier element 22 between the first and second posts 14. It should be noted that any one or more of the aforementioned steps may be accomplished by the Alzheimer's patient alone, with the assistance of a caregiver for the Alzheimer's patient, or by the caregiver alone. Furthermore, any one or more of the steps of the method 40 of the invention may be broken down into repetitive tasks to be accomplished by the Alzheimer's patient alone.

In an exemplary embodiment of the method of the invention, the cleats 16 are secured to the top surface 13 of the base 12 by an adhesive or a fastener. In yet another exemplary embodiment of the method of the invention, the first and second free ends 24, 26 of the carrier 20 are wound or wrapped around the first and second cleats 16. In still another exemplary embodiment of the method of the invention, the plurality of decorative components 30 are relatively short lengths of ribbon 32 that are tied about the carrier element 22 in the form of a bow to create the illusion of a floral arrangement.

Regardless of the foregoing detailed description of exemplary embodiments of the invention, the optimum dimensional relationships for the individual components of the invention, including variations in size, shape, thickness, form, materials, function and manner of operation, assembly and use, as well as equivalents thereof, are deemed to be readily apparent and understood by those skilled in the art. Accordingly, equivalent relationships to those illustrated in the drawing figures and described in the written description are intended to be encompassed by the present invention, the foregoing being considered as illustrative only of the principles of the invention. Furthermore, since numerous modifications and changes will readily occur to those skilled in the art, the exemplary embodiments disclosed herein are not intended to limit the invention to the specific configuration, construction, materials and operation shown and described. Instead, all reasonably predictable and suitable equivalents and obvious modifications to the invention should be construed as falling within the scope of the invention as defined by the appended claims given their broadest reasonable interpretation in view of the accompanying written description and drawings.

That which is claimed is:

1. A decorative item comprising:
an elongate base having a top surface and first and second opposite ends;
at least a pair of posts, each post secured to the top surface of the base adjacent one of the first and second opposite ends;
at least a pair of cleats corresponding to the pair of posts, each cleat secured to the top surface of the base laterally outward of the corresponding post at one of the first and second opposite ends of the base;
a carrier having a first fee end and a second fee end respectively attached to the pair of cleats and routed along the length of the base between the corresponding posts; and
a plurality of decorative components supported on and suspended from the carrier between the pair of posts.

2. A decorative item according to claim 1, wherein the carrier comprises an elongate carrier element selected from the group consisting of a cable, a rope, a string and a wire.

3. A decorative item according to claim 2, wherein the carrier element is a formable yet relatively inelastic length of wire having sufficient strength for supporting the plurality of decorative components.

4. A decorative item according to claim 1, wherein each of the pair of cleats is secured to the top surface of the base by a fastener.

5. A decorative item according to claim 1, wherein each of the pair of posts has a slot formed in a top surface of the post for receiving and retaining the carrier therein.

6. A decorative item according to claim 5, wherein the first and second free ends of the carrier are routed from the first and second pair of cleats, respectively, to the slot formed in the corresponding one of the first and second posts adjacent the opposite ends of the base.

7. A decorative item according to claim 1, wherein the base has a thickness, a width and a length and wherein the length of the base is substantially greater than the thickness and the width of the base.

8. A decorative item according to claim 1, wherein each of the plurality of decorative components comprises a relatively short length of a ribbon, and wherein each ribbon is tied about the carrier element in the form of a bow.

9. A decorative item according to claim 1, wherein each of the plurality of decorative components is an organic material selected from the group consisting of flower material and plant material.

10. A decorative item according to claim 1, wherein each of the plurality of decorative components is made of an inorganic material that is supported by and suspended from the carrier to create the illusion of a floral arrangement.

11. A method for providing therapy to a person suffering from a cognitive disorder comprising:
providing an elongate base having a top surface and opposite ends, at least a pair of posts disposed adjacent the opposite ends of the base, and a pair of cleats corresponding to the pair of posts disposed at the opposite ends of the base;
securing each of the posts on the top surface of the base adjacent one of the opposite ends of the base such that the posts extend upwardly from the top surface of the base;
securing each of the cleats on the top surface of the base laterally outward of the corresponding post at one of the opposite ends of the base;
attaching a first free end of a carrier to a first one of the pair of cleats at a first opposite end of the base;
routing the carrier from the first cleat at the first opposite end of the base to a corresponding first one of the pair of post adjacent the first opposite end of the base;
routing the carrier from the first post to a second one of the pair of posts adjacent a second opposite end of the base;
routing the carrier from the second post to a second one of the pair of cleats at the second opposite end of the base;
attaching a second free end of the carrier to the second cleat at the second opposite end of the base; and
disposing a plurality of decorative components on the carrier between the first post and the second post such that the decorative components are supported by and suspended from the carrier.

12. A method according to claim 11, wherein the step of disposing the plurality of decorative components on the carrier further comprises closely spacing the decorative components along the length of the carrier between the first and second posts.

13. A method according to claim 12, wherein each of the plurality of decorative components comprises a relatively short length of a ribbon that is tied about the carrier so as to create the illusion of a floral arrangement.

14. A method according to claim 11, wherein the step of securing the pair of cleats to the top surface of the base comprises securing each of the pair of cleats to the top surface of the base with a conventional fastener.

15. A method according to claim 11, wherein the steps of attaching the first free end of the carrier to the first cleat and attaching the second free end of the carrier to the second cleat further comprise winding or wrapping the first free end and the second free end of the carrier around the first cleat and the second cleat, respectively.

16. A method according to claim 11, wherein one or more of the steps is accomplished by an Alzheimer's patient as a means for providing a relatively simple, repetitive, yet meaningful, task for enriching the life of the Alzheimer's patient.
